(19) United States
(12) Patent Application Publication
(10) Pub. No.: US 2007/0188408 A1
(43) Pub. Date: Aug. 16, 2007

(54) Method for displaying a graphic object and communications device

(75) Inventor: Alexander Jarczyk, Freising (DE)

Correspondence Address: COHEN, PONTANI, LIEBERMAN & PAVANE, 551 FIFTH AVENUE, SUITE 1210, NEW YORK, NY, 10176, US

(73) Assignee: SIEMENS AKTIENGESELLSCHAFT, MUNCHEN (DE)

(21) Appl. No.: 10/592,806

(22) PCT Filed: Mar. 10, 2005
(86) PCT No.: PCT/EP05/51078

§ 371 Date: Sep. 14, 2006

(30) Foreign Application Priority Data
Mar. 16, 2004 (DE) 10 2004 012 897.9

(51) Int. Cl. G09G 5/00

(52) U.S. Cl. 345/9

(57) ABSTRACT

The invention relates to a method for displaying graphic objects in which the graphic objects are arranged in a virtual surface field, the virtual surface field is larger than a display field, a section of the virtual surface field is displayed in the display field, and graphic objects which are arranged outside the displayed section of the virtual surface field are projected onto the edge of the display field. The projected objects are displayed in a displacing manner such that the projected graphic objects (PGO) displayed do not overlap.

The invention relates to a method for displaying a graphics object and to a corresponding communication appliance, particularly a mobile telephone or a computer.

The constantly advancing development in the field of mobile telephones is resulting in constant miniaturization of these mobile telephones, on the one hand, and in constantly improved graphics capabilities of these mobile telephones, on the other. This prompts the users of such mobile telephones to want to make efficient use of the graphics capabilities of the mobile telephones despite the limited available surface area of the display device.

To this end, it is known practice to arrange graphics objects, such as symbols indicating a function or a program, on a virtual interface panel which is larger than an available display panel. By moving the display panel over the virtual interface panel, the portion of the virtual interface panel which is displayed on the display panel can be varied and selected by the user, so that the user is able to use a marker, for example, to select all graphics objects displayed on the virtual interface panel.

It has been found to be a drawback of this solution that a user is only ever able to see part of the virtual interface panel. The user is therefore only able to imagine the presence and position of the graphics objects which are not currently displayed on the display panel but which are arranged on the virtual interface panel.

The invention is now based on the object of specifying a technical disclosure which allows clear display of graphics objects which are arranged on a virtual interface panel which is larger than an available display panel.

This object is achieved by the features of the independent claims. Advantageous and expedient developments can be found in the dependent claims. Developments of the apparatus claim which correspond to the dependent method claims are likewise covered by the invention.

According to the invention, graphics objects which are arranged on a virtual interface panel which is larger than an available display panel are thus projected onto the edge of the display panel if they are outside of the displayed detail from the virtual interface panel. In this case, the projected graphics objects are displayed in a displacing manner such that the projected graphics objects displayed do not overlap.

The effect achieved by this is that a small available display panel can be used to display all graphics objects which are arranged on a relatively large virtual interface panel. In this context, preferably only that part of the virtual interface panel which the user has selected by positioning the display panel over the virtual interface panel is displayed to scale on the display panel. By contrast, the graphics objects which are not arranged on that portion of the virtual interface panel which is covered by the display panel are merely displayed through projection onto the edge of the display panel.

Within the context of this application, graphics objects are also understood to mean symbols, symbol parts, icons, icon parts, display windows, display window parts, pictures, picture details or texts and text elements.

The display panel is preferably formed by a display device, such as a graphics display, or part of a display device. In particular, a display panel can be produced by a graphics window.

The virtual interface panel is preferably formed by information which describes the positions of graphics objects relative to a reference point on the virtual display panel, said information being stored in a memory device. In addition to this, this information can also describe the graphics objects themselves or a display scale. This or other information is also able to determine what detail of the virtual interface panel currently needs to be displayed in what display size on the display panel. The display size or the display scale of the virtual interface panel and of the graphics objects arranged thereon can be changed by the user, for example, so that the case may also arise that the display of the virtual interface panel becomes smaller than the display panel. In this case, projected display of graphics objects can be dispensed with.

The virtual interface panel is preferably larger than a display panel if the current length and/or width dimensions of the display panel are smaller than the current length and/or width dimensions of the virtual interface panel, with the display scale which currently applies to this being used to calculate the dimensions of the virtual interface panel.

Depending on the embodiment variant, a graphics object is preferably situated outside of the displayed detail from the virtual interface panel when it is situated fully or partly outside of the displayed detail from the virtual interface panel or when its center is situated outside of the displayed detail from the virtual interface panel.

The projection onto the edge of the display panel particularly covers the case in which the graphics object is moved fully or partly from its actual position on the virtual interface panel in the direction of the center of the displayed detail from the virtual interface panel and is displayed fully or partly in the edge region of the display panel. In this context, the edge region needs to be of broad design, in particular.

Preferably, graphics objects displayed by projection are displayed in reduced size in comparison with the display scale which currently applies to the virtual interface panel, are displayed in distorted form and/or are displayed as simple geometrical shapes, such as lines.

The edge regions occupied by the projected graphics objects have a minimal space requirement in the case of line display, and even when scaled semicircle projections or “half” object projections are used for display the space requirement is very small. The result is an undistorted user interface detail in the display panel which has only a minimal space requirement (in the extreme case, it is just one pixel line of the edge region) in order to be able to provide a visual display of all graphics objects and their spatial relationship with one another.

Preferably, the size of the display of a projected graphics object is set on the basis of the distance between the displayed detail from the virtual interface panel and the position of the graphics object. The reference point which is used for calculating the distance and which represents the detail displayed is preferably formed by the center of the detail displayed or of the display panel, a corner point of the detail displayed or of the display panel, the point at which an appropriate projection line intersects the edge region of the display panel or another point in the detail displayed.

The present invention is based on central projection with additional rules which relates to the arrangement of the projected objects relative to one another and their size. In this context, the size of the objects is normalized to the difference between the minimum and maximum distance of the objects from one another. The advantage of the method is the compression of widely varying ranges in a way which allows the user to consider objects together in the tightest space and to interact with them without needing to go through various zoom steps in the process. If a trip from Munich to Tokyo is considered, for example, in which information (such as travel photographs) at Munich airport, at Tokyo airport, at various attractions in Tokyo etc. has been recorded in the system, the user can see the information from Munich directly next to the information from Tokyo without needing to perform a zoom operation in order to do so. In addition, he can use simple interactions to use this compressed information display, e.g. for quickly navigating (what kind of information is important at Munich airport, which information is important at Tokyo airport etc.).

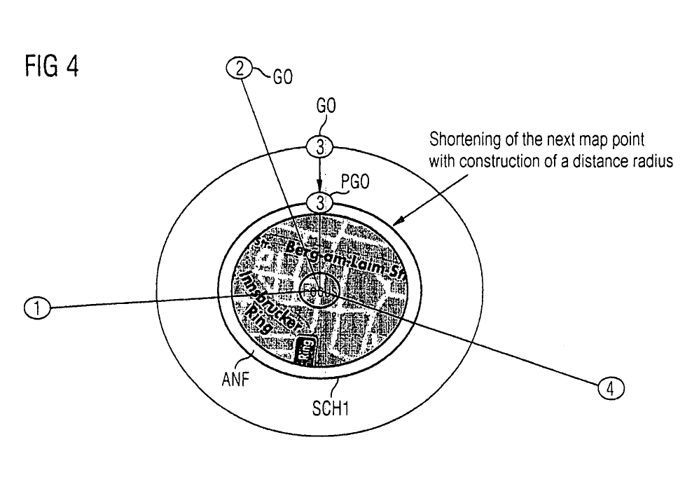

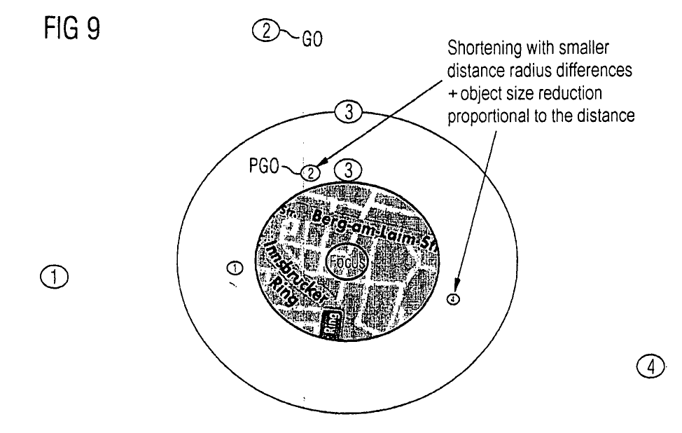

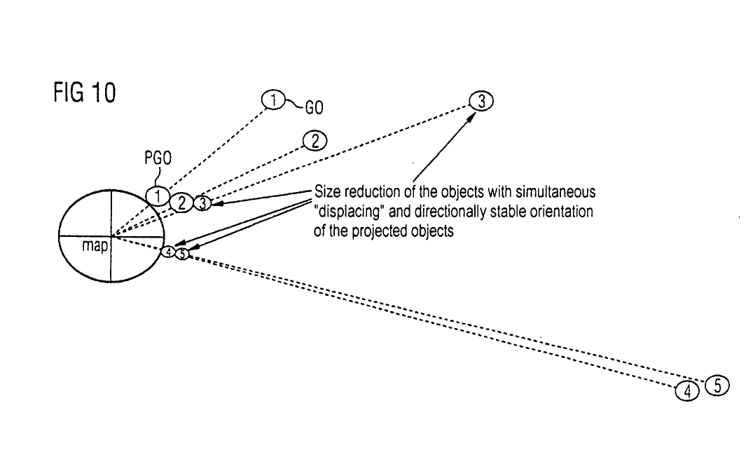

The text below briefly explains preferred refinements of the invention:
a. Central projection
   Graphics objects (objects) which are situated outside of the display panel (peephole), that is to say are situated outside of a displayed map detail, for example, are projected toward the center at the edge thereof. In this case, the locations are separated from the peephole by circular icons or at least by a circular invisible border (FIG. 4).
b. Calculation of the distance between the projected graphics objects
   In this context, a shell-like arrangement is used so long as the objects do not touch one another after projection. As far as its “thickness” is concerned, this system can vary the thickness of a projected object as far as the thickness zero (see FIGS. 4 to 7 and 8). Particularly when the shell thickness zero is selected, the method is reliant on the further points displacement and size variation so as still to be able to give the user the feeling of range with simultaneous direction information.
c. Size calculation on the basis of distance
   So as still to allow the range of the graphics objects to be assessed after projection onto the edge of the peephole, the method applies the following size variation algorithm (see FIGS. 9 and 10):
      1. First of all the minimum and maximum distances of all objects situated outside of the peephole are calculated.
      2. The maximum icon size is then stipulated for the object at the shortest distance, and the minimum icon size is stipulated for the object at the greatest distance.
      3. Objects whose range is in between have their size displayed between the two extremes using either linear or else nonlinear interpolation. In this context, the nonlinear determination of the size is oriented to the density distribution of the projected objects on a distance scale (the more objects there are in a particular interval of ranges the greater the level of detail for the size change, and vice versa).
d. Displacing arrangement of the projected graphics objects
   If, following projection of the graphics objects, at least one overlap in the circular areas thereof can be recorded then this/these overlap(s) is/are resolved and the following algorithm is obtained from the start when calculating the projections (see FIG. 10):
      1. From the set of objects which have not yet been projected at the edge of the peephole, the one situated closest to the center of the peephole is always taken and attempted to be projected at the edge of the peephole.
      2. If the projection attempt results in an overlap then the projected object on the projection beam is removed further from the center until there is no longer any overlap with any previously projected objects.
      3. This is continued until all objects are projected without overlap at the edge of the peephole.

The invention is described in more detail below using preferred exemplary embodiments which are explained with reference to the figures listed below:

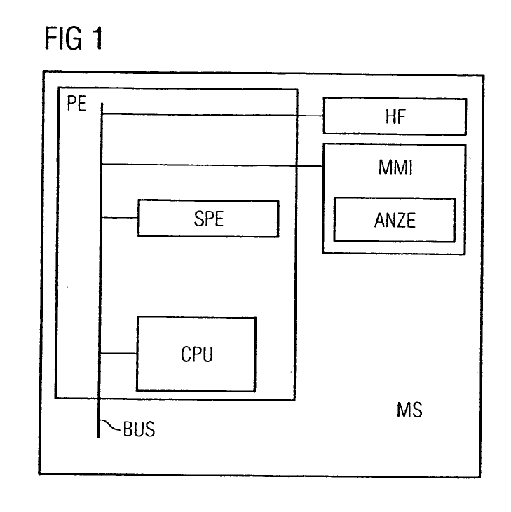

FIG. 1 shows a block diagram of a mobile telephone;

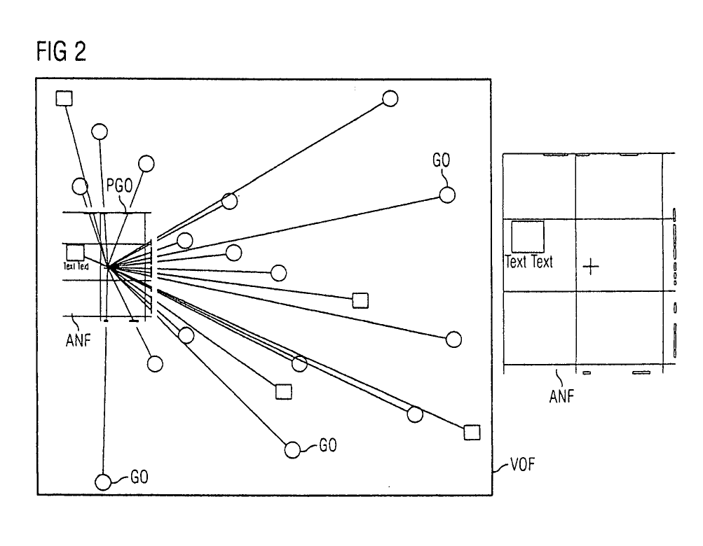

FIG. 2 shows a first exemplary embodiment of the display and projection of graphics objects;

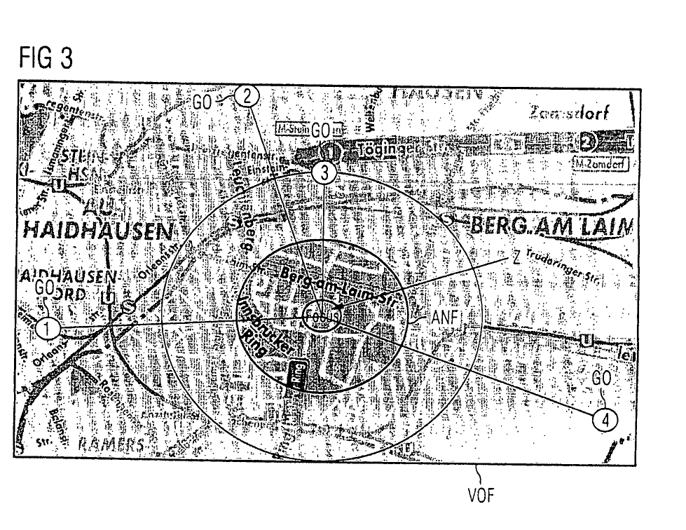

FIG. 3 shows a second exemplary embodiment of the display and projection of graphics objects;

FIG. 4 shows a third exemplary embodiment of the display and projection of graphics objects;

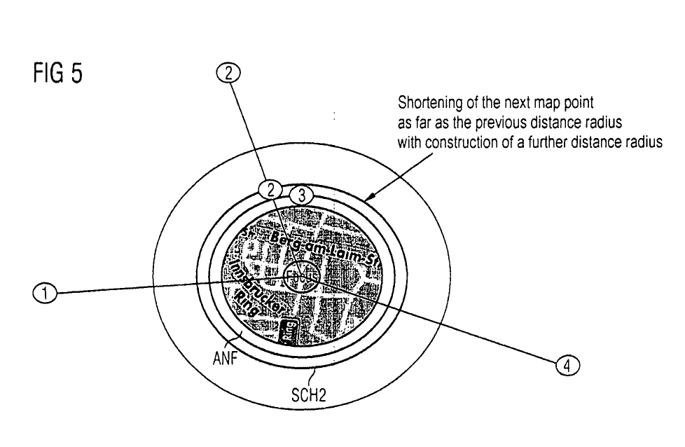

FIG. 5 shows a fourth exemplary embodiment of the display and projection of graphics objects;

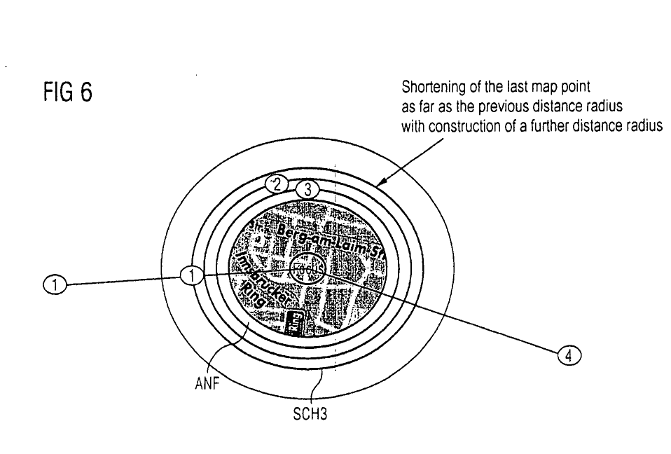

FIG. 6 shows a fifth exemplary embodiment of the display and projection of graphics objects;

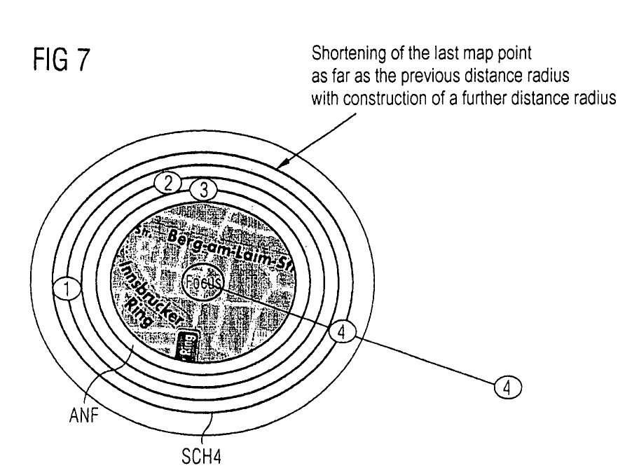

FIG. 7 shows a sixth exemplary embodiment of the display and projection of graphics objects;

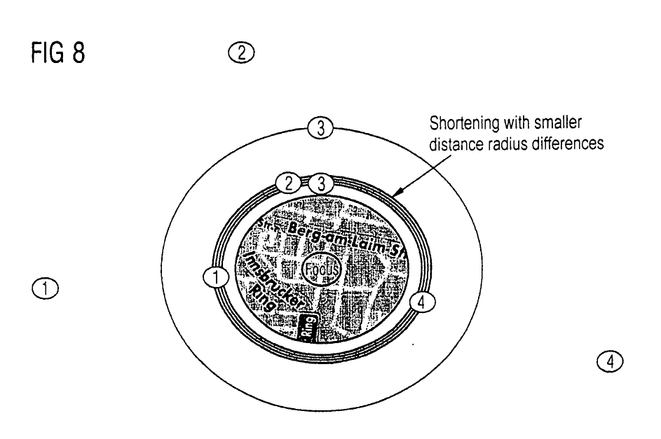

FIG. 8 shows a seventh exemplary embodiment of the display and projection of graphics objects;

FIG. 9 shows a eighth exemplary embodiment of the display and projection of graphics objects; and

FIG. 10 shows a ninth exemplary embodiment of the display and projection of graphics objects.

FIG. 1 shows a mobile telephone MS which contains an operator control device MMI, a radio frequency device HF and a processor device PE. The operator control device MMI comprises a display device ANZE, such as a graphics display, and operating elements, such as keys or softkeys.

To control the mobile telephone MS, the operator control unit MMI in the mobile telephone MS and the processes which are executed on the mobile telephone, a program-controlled processor device PE such as a microcontroller is provided which can also comprise a processor CPU and a memory device SPE.

Depending on the embodiment variant, further components—associated with the processor device, belonging to the processor device, controlled by the processor device or controlling the processor device—such as a digital signal processor or further memory devices may be arranged within or outside of the processor device PE in this context, the basic function of said components in connection with a processor device for controlling a mobile telephone being sufficiently well known to a person skilled in the art and therefore not being discussed in more detail at this juncture. The various components can use a bus system BUS or input/output interfaces and possibly suitable controllers to interchange data with the processor CPU.

The memory device SPE stores the program data, such as the control commands or control procedures etc., which are used for controlling the mobile telephone and the operator control unit MMI, and information regarding the description of the virtual interface panel together with graphics objects.

FIG. 2 shows a virtual interface panel VOF and a smaller display panel ANF displaying a detail from the virtual interface panel VOF. Graphics objects GO arranged on the virtual interface panel VOF are projected along the lines shown onto the edge of the display panel ANF, and the graphics objects PGO projected in this manner are shown there as lines. To provide clarification, the display panel ANF is shown once again on a larger scale on the right. In line with one variant embodiment of the invention, the user can operate a navigation key in order to move the display panel ANF over the virtual interface panel VOF or to move the virtual interface panel VOF below the display panel ANF. There is also a change in the display scale or in the zoom factor relating to the virtual interface panel VOF, particularly to the portion of the virtual interface panel VOF which is displayed by the display panel ANF.

FIG. 3 shows an electronic map in the form of a virtual interface panel VOF, a detail from said electronic map being displayed in a display panel ANF. Graphics objects GO are arranged on the virtual interface panel VOF at a distance from a point which is displayed—in the center of the display panel ANF—from the virtual interface panel.

FIG. 4 shows the projection of a graphics object (GO) 3, which is situated outside of the displayed detail and is at the shortest distance from the center, at the edge of the display panel ANF. In this case, the graphics object 3 is projected onto a first shell SCH1 of the edge (projected graphics object PGO).

FIG. 5 shows the corresponding projection of a graphics object 2, which is situated outside of the displayed detail and is at the second shortest distance from the center, at the edge of the display panel ANF. In this case, the graphics object 2 is projected onto a second shell SCH2 of the edge.

FIG. 6 shows the corresponding projection of a graphics object 1, which is situated outside of the displayed detail and is at the third shortest distance from the center, at the edge of the display panel ANF. In this case, the graphics object 1 is projected onto a third shell SCH3 of the edge.

FIG. 7 shows the corresponding projection of a graphics object 4, which is situated outside of the displayed detail and is at the fourth shortest distance from the center, at the edge of the display panel ANF. In this case, the graphics object 1 is projected onto a fourth shell SCH4 of the edge.

In line with one refinement of the invention, the distance between the shells is variable. If the distance between the shells is set to zero, i.e. the radii of all shells are of equal size, the illustration shown in FIG. 8 is obtained.

FIG. 9 shows the projection of the graphics objects GO onto shells with slightly different radii combined with a variation in the size of the display of the projected graphics objects PGO.

FIG. 10 shows a projection of the graphics objects GO with a variation in the size of the display of the projected graphics objects PGO. In this case, displays of projected graphics objects PGO which would overlap are displaced such that an overlapping display is prevented but the displays of the projected graphics objects (particularly the centers of these displays of the projected graphics objects) are nevertheless situated on the line of projection between the center and the graphics object (directionally stable displacement).

The present invention can advantageously be used for the following applications:
1. Rapid browsing of a picture database which has received the information for the location (at which the picture was taken) from location based services or direct GPS position finders. Here, particularly images which are not quite at the focal point are nevertheless projected as distorted but directionally correct information at the edge of the peephole.
2. Rapid browsing of a sound database which has received the information for the location (at which the sound was recorded) from location based services or direct GPS position finders and has been recorded by the user, e.g. using a dictaphone functionality of the mobile device, while it is at a location.
3. Convenient display of local and trunk routes, particularly when transfer locations are further away than the current close view would allow.
4. Journey planning which allows time and space dependent alarms to be prepared which are then triggered during the actual journey by location based and/or GPS based services.
5. Holiday browsing through all kinds of “memories” which can be displayed using multimedia.
6. Journey information system.
7. Tourist information system.

In addition to the abovementioned embodiment variants of the invention, the invention covers a multiplicity of further embodiment variants which will not be described in further detail here, but which can easily be implemented in practice using the exemplary embodiments described.

1.-4. (canceled)

5. A method for displaying graphics objects arranged on a virtual interface panel, wherein the virtual interface panel is an electronic graphically displayable representation of an area including graphics objects associated with respective positions on the virtual interface panel, wherein said method comprises the steps of:
providing a display panel displaying a portion of the virtual interface panel, wherein the virtual interface panel is larger than the displayed portion of the virtual interface panel and; and
projecting graphics objects which are associated with positions outside of the displayed portion onto the edge of the display panel and displaying the projected graphics objects on the edge of the display panel, the projected graphics objects being displaceably displayed to prevent overlap of the displayed projected graphics objects on the display panel.

6. The method of claim 5, wherein the projected graphics objects are displayed at a reduced size from their original size.

7. The method of claim 6, wherein the amount of the reduction of the display size of the projected graphics objects is a function of the distance between the center of the displayed portion of the virtual interface panel and the associated position of the projected graphics object on the virtual interface panel.

8. The method of claim 5, wherein the virtual interface panel comprises an electronic map.

9. A communication device, comprising:
a display device for displaying a display panel comprising a portion of a virtual interface panel, wherein the virtual interface panel comprises an electronic graphically displayable representation of an area and having graphics objects associated with respective positions on the virtual interface panel; and
a processor configured to display the portion of the virtual interface panel on the display device, the portion being smaller than the virtual interface panel, and to project graphics objects which are associated with positions outside of the displayed portion onto the edge of the display panel and display the projected graphics objects on the edge of the display panel, the projected graphics objects being displaceably displayed to prevent overlap of the displayed projected graphics objects.

10. The communication device of claim 9, wherein said virtual interface panel comprises an electronic map.
